(19) United States
(12) Patent Application Publication
(10) Pub. No.: US 2010/0326598 A1
(43) Pub. Date: Dec. 30, 2010

(54) LOW VOLATILE ORGANIC COMPOUND ADHESIVE FOR ATTACHING THERMOPLASTIC POLYOLEFIN ROOFING MEMBRANES

(76) Inventor: Michael N. Atwater, Salem, NH (US)

Correspondence Address: Bell & Manning, LLC, 122 E. Olin Avenue, Suite 290, Madison, WI, 53713, US

(21) Appl. No.: 12/824,002

(22) Filed: Jun. 25, 2010

Related U.S. Application Data
(60) Provisional application No. 61/221,353, filed on Jun. 29, 2009.

(51) Int. Cl. C09J 153/02; B32B 37/12

(52) U.S. Cl. 156/334; 524/365; 524/315; 524/505

(57) ABSTRACT

Adhesive compositions formulated with blends of styrene-isoprene-styrene block copolymers and hydrocarbon resins are provided. Also provided are methods for bonding substrates, including roofing membranes, using the adhesive compositions. The adhesive compositions are characterized by high solids contents, low viscosities and improved bonding characteristics, including high peel strengths when adhered to roofing membranes, such as thermoplastic polyolefin (“TPO”) membranes.

### CROSS-REFERENCE TO RELATED APPLICATIONS

This application claims priority to U.S. provisional patent application Ser. No. 61/221,353, filed on Jun. 29, 2009, the entire disclosure of which is incorporated herein by reference.

### FIELD OF THE INVENTION

The present invention relates to low volatile organic compound (VOC) solvent-based adhesive compositions formulated with blends of styrene-isoprene-styrene block copolymers (SIS copolymers) and hydrocarbon resins and to methods for using the adhesive compositions to bond substrates.

### BACKGROUND

There are many options for waterproofing flat and nearly flat roofs. Hot tar is one solution that is cost effective but often cracks under temperature cycling, causing leaks. In addition, the black color makes it very difficult to keep the building cool during hot, sunny weather. Flexible, waterproof single-ply membranes are another option. These have been in use since 1970 and the earliest of these was kept in place by ballasting with rocks or other aggregates. Alternatively, the membranes have been fastened to roof decks mechanically using screws and anchor plates. Both of these processes are time-consuming and any penetration of the membrane, whether by screws or rocks, risks water leaks.

Efficiency dictates that wide sheets of roofing membranes be used. These sheets must be overlapped and spliced together during installation to provide uniform surfaces. Adhesives are used in the splicing operation as well as for bonding to wood, concrete or isocyanurate insulation roof deck.

Ethylene-propylene-diene terpolymer (EPDM) has been used to cover flat industrial and commercial roofs but suffers from the deficiency of not adhering well to itself, especially when extensively vulcanized. Polychloroprene adhesives have been proposed for bonding EPDM. Unfortunately, conventional polychloroprene adhesives do not bond well to the nonpolar EPDM and are not particularly water-resistant, limiting the effective lifetime of the roof. Miller, et al (U.S. Pat. No. 4,897,137) describe an isocyanate-containing primer that improves the adhesion of polychloroprene adhesive to EPDM but involves an additional priming step. In U.S. Pat. No. 4,501,842, Chmiel, et al, add an isocyanate component to the butyl rubber adhesive composition to eliminate the additional step but this expedient decreases the shelf life of the adhesive substantially. A more stable two-part quinoid cure system is disclosed by Nussbaum, et al (U.S. Pat. No. 4,881,996), but the solvents described are VOCs, which are hazardous to the environment. A self-adhering, heat sealable sheet material for roofing is detailed by Davis, et al (U.S. Pat. No. 5,162,436), but the extra heat sealing step and equipment are costly and labor-intensive. The efficacy of the adhesive can also be improved by pre-application to the membrane and installation by a peel and stick process (Fisher, U.S. Pat. No. 6,794,449) but there is added weight to the membrane rolls making them more difficult to position and the release liner must be disposed of A bonding pad tape having adhesive on both sides for the splicing joint (Wasitis, U.S. Pat. No. 5,800,891) still has release liner but EPDM rolls do not have the extra weight. Unfortunately, an extra adhesive activation step (primer) is required after the release liner is removed, adding time and complexity to the process and complicating repairs. Wen, et al (U.S. Pat. No. 5,872,203), use a solvent-free polyurethane adhesive composition to bond polymeric roofing materials to roof deck substrates but the adhesive contains unhealthy isocyanate and the two-part system is difficult to use.

While EPDM single-ply roofing membranes have excellent flexibility, poor light reflectivity leads to higher energy costs. Moreover, membrane shrinkage often leads to seam failure and leakage. Although they are more expensive than EPDM, polyvinyl chloride (PVC) membranes have been used since the 1960's and possess better light reflectivity since they are available in white or lightly tinted versions. In addition, PVC sheeting is more resistant to a much wider variety of potentially destructive chemicals. Heat-welded seams all but eliminate seam failure (adhesives are not generally used for splicing) but the procedure is both costly and time-consuming. Finally, there is always the possibility of plasticizer migration causing seam failure and leakage through micro-cracking.

Thermoplastic polyolefin (TPO) membranes are also used in single-ply roofing applications. TPO membranes are noted for long service, chemical resistance, reduced shrinkage, high reflectivity, good weatherability and improved impact and puncture resistance. In addition, TPO is recyclable. In U.S. Pat. No. 6,864,195, Peng discloses a heat-weldable TPO roofing membrane that is pliable and easy to install, has good bond strength with the roof and does not require the use of supporting scrim. Naipawer, et al (U.S. Pat. No. 6,863,944) reports an adhesive-backed TPO roofing membrane that has resistance to wind lift without the need for mechanical fastening. The extra weight of the membrane roll and the issue of proper disposal of the release strip are once again noted as disadvantages of this type of process. The solvent-free peel and stick adhesive claimed by Fisher (U.S. Pat. No. 6,794,449) for use with EPDM also works for TPO.

Unfortunately, TPO's non-polar surface leads to adhesion problems for any coating. In order to adhere paint to TPO, Ryntz, et al (U.S. Pat. No. 6,391,461), functionalize both the TPO and the coating. McGee, et al (U.S. Pat. Nos. 6,300,414 and 6,841,619), report the use of a primer in order to bond a curable coating composition to TPO. A more stable adhesion promoter is described by Merritt, et al (U.S. Pat. No. 6,939,916). Bhattacharya, et al (U.S. Pat. Nos. 6,875,472 and 7,238,235), disclose an adhesion promoter application system that allows a paint coat to be applied to the surface of a TPO component without the need to first apply a primer coat. Modification of the TPO incurs extra expense while a primer involves an extra step.

On the surface, water-based adhesives would seem to be the ideal roofing adhesive candidate, but on closer examination of roofing adhesive requirements, water-based adhesives fall short on many fronts. Green strength, or the ability of two sheets of material that have been coated with the adhesive to develop virtually immediate adhesive strength when placed in contact with each other, is an extremely important adhesive property. Most current adhesive compositions require 2-7 days at room temperature to reach maximum strength at the seam splice. During this time, the roof membrane splices can experience strong winds, temperature extremes, rain, humidity and installer traffic that can cause seam failure if green strength is not high enough to form a quick bond. Typically, water-based adhesives dry more slowly and do not have the green strength of solvent-based adhesives. In addition, moisture and humidity have a more deleterious effect on water-based adhesives with a potential to cause premature bond failure and substantially prolong the time to maximum adhesive strength. Finally, water-based adhesives cannot be applied when temperatures are below freezing.

Solvent-based adhesives dry quickly, have excellent green strength and can be used at lower temperatures than, for example, water-based adhesives. Unfortunately, the workhorse solvents for adhesives, hexane, xylene and toluene are volatile organic compounds and are harmful to the environment as well as to the health of the installers.

### BRIEF SUMMARY

One embodiment of the invention provides an adhesive composition comprising a hydrocarbon resin, a styrene-isoprene-styrene block copolymer having a styrene content of no greater than 25 weight percent, based on the total weight of the polymer; at least one organic solvent selected from the group consisting of acetone, methyl acetate, t-butyl acetate and parachlorobenzotrifluoride; and 0 to 20 weight percent of one or more additional organic solvents, based on the total weight of the composition. Other optional components include stabilizing agents. In this embodiment, the adhesive composition has a solids content of at least 25 weight percent, a viscosity of no greater than 5000 cps at 25° C., and a 7-day 180° peel strength at room temperature of at least 1253 grams/cm (7 lbs/inch), as measured by a modified ASTM D903 (defined herein).

The composition can be characterized in that its 180° peel strength remains the same, or increases, after heating for 7 days at 70° C. In some formulations, the composition does not exhibit zippering when bonded to a TPO membrane and CDX plywood and heated for 7 days at 70° C. For the purposes of this disclosure, a composition does not exhibit zippering if a 1 inch wide membrane of the TPO (i.e., a GAF TPO membrane) adhered to the CDX plywood can be separated by hand and when the force to start the peel is exceeded, the TPO strip unzips readily.

In some embodiments, the composition comprises no greater than 18 weight percent of the one or more additional organic solvents and has a solids content of at least 35 weight percent. In these embodiments, the styrene-isoprene-styrene block copolymer can have a styrene content of no greater than 20 weight percent, based on the total weight of the copolymer. These embodiments include compositions that comprise 30 to 70 weight percent hydrocarbon resin, based on the total weight of the composition, and 30 to 70 weight percent styrene-isoprene-styrene block copolymer, based on the total weight of the composition. In such embodiments, 60 to 90 weight percent of the organic solvent in the composition is selected from the group consisting of acetone, methyl acetate, t-butyl acetate and parachlorobenzotrifluoride.

The one or more additional organic solvents can be toluene. The toluene can make up, for example, 10 to 18 weight percent of the composition, based on the total weight of the hydrocarbon resin, the styrene-isoprene-styrene block copolymer, and the organic solvents.

The compositions can be used for bonding a first surface to a second surface by applying the compositions to at least one of the first surface and the second surface and contacting the first surface to the second surface. One or both the of the first and second surfaces can be the surface of a roofing membrane, such as a thermoplastic polyolefin membrane, or a building substrate, such as brick, concrete or aluminum.

### DETAILED DESCRIPTION

Adhesive compositions formulated with blends of styrene-isoprene-styrene block copolymers and hydrocarbon resins are provided. Also provided are methods for bonding substrates, including roofing membranes, using the adhesive compositions.

The adhesive compositions include a hydrocarbon resin, a styrene-isoprene-styrene block copolymer (“SIS copolymers”) and at least one organic solvent that is certified as a VOC-exempt solvent by the U.S. Environmental Protection Agency. Examples of such ‘exempt’ solvents are acetone, methyl acetate, t-butyl acetate and parachlorobenzotrifluoride. The adhesive composition can also optionally include a small amount of additional organic solvents. The adhesive compositions can be characterized by high solids contents, low viscosities and improved bonding characteristics, including high peel strengths when adhered to roofing membranes, such as thermoplastic polyolefin (“TPO”) membranes.

The high solids content is desirable because higher solids mean greater coverage per gallon and less solvent to evaporate. In some embodiments, the adhesive compositions have a solids content of at least 25 weight percent. This includes embodiments in which the adhesive compositions have a solids content of at least 35 weight percent and further includes embodiments in which the adhesive compositions have a solids content of at least 45 weight percent.

The present adhesive compositions are sufficiently viscous to allow them to be applied to roofing membranes using standard techniques. In some embodiments, the adhesive compositions have a viscosity at 25° C. of no greater than about 5000 cps. This includes embodiments in which the adhesive compositions have a viscosity at 25° C. of no greater than about 2600 cps. Adhesive compositions with such low viscosities can be applied using large brushes. Moreover, the boiling point of the solvent mix (described in more detail, below) can be adjusted so that the evaporation rate provides the installer with enough time to apply the adhesive.

Evidence of the improved bonding characteristics of the adhesive compositions is provided by their resistance to zippering. For example, the bonds formed with the present adhesive compositions can be characterized by the fact that they do not exhibit zippering after significant periods of aging. “Zippering” in the roofing field is the complete adhesive failure of the bond at the roofing membrane substrate with minimal peel force once the initial bond strength is exceeded. Zippering is a concern because prolonged high winds concentrated on an older roof can result in failure of many membranes at the roofing membrane substrate, resulting in extensive damage to the contents and structure of the building below. Therefore, it is advantageous that the adhesive compositions described herein resist zippering. In fact, in at least some embodiments, the present adhesive compositions provide bonds to substrates that are more reliable and exhibit adhesive failure of the bond at the roof substrate and not at the membrane substrate or, in some instances, cohesive failure.

The superior bonding characteristics of the present adhesive compositions are also demonstrated by resistance to deterioration after significant periods of heat aging. This is surprising, because the bond strength of conventional adhesives, including roofing adhesives decrease sharply with exposure to elevated temperatures. As a result the peel strength of the adhesives lose strength after heat aging. In contrast, the peel strength of at least some embodiments of the present adhesive compositions actually improves after heat aging. For example, the 180° peel strength of the adhesives can be at least about 1253 grams/cm (about 7 lbs/inch) after 7 days at room temperature. The same bond can have a peel strength that remains the same, or even increases, after heating at 7 days at 70° C., after 28 days at 70° C., or even after 69 days at 70° C.

Without wishing or intending to be bound by any particular theory of the invention, the inventors believe that the ability to provide a high solids, low viscosity, and low VOC adhesive composition with enhanced bonding properties is due, at least in part, to the use of SIS copolymers having relatively high isoprene contents. The use of such copolymers is thought to be advantageous because many substrates, including TPO substrates, present a low polarity surface and, therefore, the isoprene in the SIS copolymer can encourage the wetting necessary for good adhesion because it has a similar contact angle to the TPO. This could explain why adhesives formulated from low styrene-content SIS copolymers exhibit surprisingly improved bond strengths compared to adhesives formulated from higher styrene-content SIS. In addition, SIS slowly oxidizes by chain scission rather than by relatively faster crosslinking. While one would expect the loss of molecular weight of the SIS rubber to slowly weaken the adhesive bond, the inventors have discovered that good wetting and adhesion is possible even after long exposure to heat (see Example 2 below). One possible explanation for this observation is that the SIS-based adhesive does not experience as much contraction as an adhesive based on a copolymer, such as SBS, that undergoes crosslinking-induced contraction which may lead to embrittlement and adhesive failure. In summary, it is believed that the polarity of the SIS and its mechanism of decomposition encourage wetting of low polarity surfaces, help to maintain peel strength during exposure to heat and prevent premature embrittlement of the compositions. In addition, the rheological properties of SIS in the adhesive composition can provide high solids without high viscosity.

The SIS copolymers in the present adhesive compositions desirably have a styrene content no greater than about 25 weight percent. This includes SIS copolymers having a styrene content of 0.01-22 weight percent and further includes SIS copolymers having a styrene content of 0.01-19 weight percent. The SIS copolymer may be linear or radial. However, in some embodiments a linear configuration is desirable because it further increases solubility. Increased solubility is advantageous because, once the solvent system ratio is fixed to optimize solubility, evaporation rate and VOC level, the viscosity can be kept low by ensuring that the resin and the adhesive rubber block are soluble in that solvent system. The SIS copolymers of the present adhesives appear to be close to ideal rubbers in terms of solubility in the present solvent mixtures, which are described in greater detail below.

Suitable, commercially-available linear SIS tri-block copolymer of high isoprene content include, but are not limited to, those sold under the tradenames Kraton D1113P, D1117P, D1161P and D1163P, all available from Kraton Polymers, and Vector 4113A and 4114A, both available from Dexco Polymers LP. The block copolymer component may be a combination of such block copolymers.

In addition to the SIS copolymers, the present adhesive compositions include an aliphatic hydrocarbon resin. This resin should be selected to provide tack without detracting from heat resistance. In addition, if the adhesive is to be used for TPO roofing membranes the hydrocarbon resin should provide wetting properties so that the roofing adhesive will spread on the TPO roofing membrane. The resin should also be selected such that it is physically compatible with the SIS copolymer rubber component and other constituents of the adhesive composition. The aliphatic hydrocarbon resin is desirably a high melting resin with a high softening point in order to maximize its heat resistance. Examples of suitable resins include, but are not limited to, those sold under the tradenames Escorez 1102, 1304, 1310LC and 1315, all available from Exxon Mobil Chemical; Piccotac 1095, 1098, 1100 and 1115, all available from Eastman Chemical Company; Nevtac 100, 115 and Super Nevtac 99, all available from Neville Company and Wingtack 95 and Plus, both available from Sartomer Company. Any combination of such aliphatic hydrocarbon resins may also be used.

Other resins from the categories of hydrogenated polyalicyclic, aromatic hydrocarbon, aromatic/aliphatic hydrocarbon, coumarone indene or ester of hydrogenated rosin may also be used if solubility, heat resistance and bond strength characteristics are met.

The solvent system for the present adhesive compositions is designed to provide a formulation that is VOC-compliant (as determined, for example, by the relevant guidelines of the U.S. Environmental Protection Agency), but still has both a high solids content and a viscosity that is sufficiently low to allow for relatively easy application. For the reasons discussed above, the inventors were able to achieve all of these properties based on the identification of certain SIS copolymers with an appropriate S:I ratio which have excellent solubility in VOC-exempt solvents.

In addition to the VOC-exempt solvents, the adhesive compositions may include other, non-exempt solvents, such as toluene, and alkanes, such as hexane and heptane. When the non-exempt solvents are included, they should make up no greater that 30 weight percent of the solvent system and no greater than about 18 weight percent of the entire adhesive composition. This includes embodiments where the non-exempt solvents make up no greater than about 25 weight percent of the solvent system. A preferred non-exempt solvent for roofing adhesive compositions is toluene because of its ability to dissolve a wide variety of rubber and resin components, to wet the TPO surface to encourage quick adhesion (green strength) and (because of its relatively high boiling point) to provide a reasonably long time to spread the adhesive.

By way of illustration only, in some embodiments the solvent system includes toluene, a low-boiling VOC-exempt solvent such as methyl acetate, and a high-boiling VOC-exempt halogenated aromatic hydrocarbon such as Oxsol 100. These solvent systems provide good solubility, low VOC (e.g., compliant with the roofing standards of Southern Calif.'s strictest district, the South Coast Air Quality Management District), and long open time. The solvent system can include, for example, 15-30 weight percent (e.g., 18-25 weight percent or 20-24 weight percent) toluene, 50-75 weight percent (e.g., 55-70 weight percent or 58-68 weight percent) methyl acetate, and 8-25 weight percent (e.g., 10-20 weight percent or 12-18 weight percent) halogenated aromatic hydrocarbon.

The present adhesive compositions can be used for a variety of materials, but are particularly well-suited for use with TPO membranes. The TPO membranes may be bonded to other TPO membranes or to other building substrates including, but not limited to, brick, concrete, aluminum and galvanized steel.

As illustrated in the Examples below, the adhesive compositions have low VOC content, provide adhesion to TPO that maintains consistent peel strength with heat aging and successfully bonds many commercial TPO membranes.

A typical TPO is a melt blend or reactor blend of a polyolefin plastic (often a polypropylene plastic) with a non-crosslinked olefin copolymer elastomer (OCE). The latter can be an ethylene-propylene copolymer or an ethylene-propylene-diene rubber (EPDM), whose diene component is preferably non-conjugated. Examples of non-conjugated dienes include 1, 4-pentadiene, 1, 4- and 1, 5-hexadiene, 1, 4-heptadiene, 1, 4- and 1, 8-octadiene, cyclooctadiene and a host of norbornene derivatives. Each of the two components of the TPO has its own function: the polyolefin plastic provides temperature resistance and rigidity while the OCE lends toughness, flexibility and resilience to the TPO. Many different types of TPO are possible with each having different reactivity, polarity and surface characteristics. In commercial production are ROYALENE, available from Uniroyal Chemical Company and VISTALON, manufactured by Exxon-Mobil Chemical Company.

In addition to the above ingredients, various additives may optionally be included in the adhesive compositions. These include stabilizing agents, such as antioxidants and UV stabilizers to prevent premature aging of the isoprene blocks from oxidation and chain scission. Suitable antioxidants or mixtures of antioxidants include, but not limited to, Irganox 1010, 1076 and 1520, available from Ciba-Geigy; BNX-1010, available from Mayzo, Inc. and Wingstay C, K, L, S or T, all available from Sartomer Company. In addition, in some embodiments it is desirable that a hindered amine light stabilizer (HALS) such as, but not limited to, Tinuvin 770, available from Ciba-Geigy, be used as well as a UV absorber such as, but not limited to, Tinuvin P, available from Ciba-Geigy. The adhesive composition may also contain filler (such as clay, fumed silica, microspheres, silica or combinations thereof), pigments or dye (such as carbon black, titanium dioxide, E-6089 Oil Yellow or combinations thereof) and flame retardants (such as antimony oxide, decabromodiphenyl oxide or combinations thereof).

The amount of each of the components in the present adhesive compositions can vary depending upon the specific components chosen and the materials to be bonded. By way of illustration, in some embodiments the adhesive compositions include about 30 to 70 weight percent hydrocarbon resin, about 30 to 70 weight percent SIS block copolymer and the remainder solvents, based on the total combined weight of the hydrocarbon resin, SIS block copolymer and solvent. In these embodiments, the solvent system will desirably include 60-90 weight percent of at least one organic solvent selected from the group consisting of acetone, methyl acetate, t-butyl acetate and parachlorobenzo-triflouride.

### Examples

In the examples described below and in the evaluation of the products formulated in accordance with the present invention, the following tests were used to evaluate bond strength (180 degree peel strength), heat resistance (180 degree peel strength after heat aging at 70° C.) and green strength.

180 Degree Peel Strength

A slight variation of ASTM D903 was used to measure 180° peel strength. This variation of ASTM D903 will be referred to as the “modified ASTM D903” for the purposes of this disclosure. In this variation, the substrates were TPO and CDX plywood (5″×19.25″×¼″). Substrates were brushed with a single coat at the recommended coat weight, and then allowed to dry to the touch (20 minutes) before bonding and J-rolling. The TPO membrane was glued to the CDX plywood, flush at the top and overhanging the bottom of the plywood. The bottom inch of the plywood was masked off with tape so that the Lloyd's Tester jaws could grip it firmly. Strips 1″ wide were cut just prior to testing. Four samples could fit in the 5″ width, leaving 0.5″ of unused membrane at either end of the strip. The peel distance was 10″. For the purposes of this test, the TPO membrane can be a Firestone TPO membrane sold under the tradename Firestone Ultraply® TPO Membrane (hereinafter “Firestone Membrane”) at the time of this filing or a GAF TPO membrane sold under the tradename EverGuard® TPO Membrane (hereinafter “GAF Membrane”) at the time of this filing. Room temperature samples were conditioned for varying times at room temperature before pulling at 2″ per minute on a Lloyd's Tester. Note: This represents a modification of ASTM D903 in which pulling is carried out at 12″/min. The “70° C. samples” were conditioned for 7 days at room temperature before being put into the 70° C. oven for varying durations of conditioning at 70° C. Three replicates were run for each sample at each set of conditions. The reported value is an average of the three readings.

Quick Grab

A qualitative evaluation of the formulations was also performed by applying the adhesive compositions to a TPO membrane, bonding the TPO membrane to CDX plywood and qualitatively noting the quality of the bond. Observations of the strength of the bond and the quality and number of the adhesive fibrils (“legs”) when the bond was pulled apart were the basis for this qualitative assessment.

### Comparative Examples 1-4

### SIS Rubber

The following comparative examples were prepared using SIS copolymers of differing styrene content and qualitatively evaluated (high, medium and low) for effectiveness in adhering TPO to CDX plywood.

### Comparative Example 1

Into a quart jar were weighed 100 grams SIS rubber (40 weight percent styrene), 60 grams hydrocarbon resin, 40 grams polymerized modified rosin ester, 10 grams naphthenic oil and 2 grams stabilizer. Next, 286.2 grams acetone, 286.2 grams t-butyl acetate and 63.6 grams toluene were added and the solids were dissolved by mixing. The solids content and VOC content of the adhesive composition, and the styrene content of the SIS copolymer in the adhesive composition of this example (and all other examples) is shown in Table 1.

TABLE 1

| Example | % Solids | % VOC | % S in SIS |
|---|---|---|---|
| C-1 | 25.0 | 41.3 | 40.0 |
| C-2 | 25.0 | 41.3 | 30.0 |
| C-3 | 25.0 | 41.3 | 15.0 |
| C-4 | 25.0 | 41.3 | 15.0 |
| w-1 | 65.0 | 23.3 | 15.0 |
| w-2 | 50.2 | 16.6 | 15.0 |
| w-3 | 38.6 | 13.4 | 15.0 |

### Comparative Example 2

Into a quart jar were weighed 100 grams SIS rubber (30% styrene), 60 grams hydrocarbon resin, 40 grams polymerized modified rosin ester, 10 grams naphthenic oil and 2 grams stabilizer. Next, 286.2 grams acetone, 286.2 grams t-butyl acetate and 63.6 grams toluene were added and the solids were dissolved by mixing.

### Comparative Example 3

Into a quart jar were weighed 100 grams SIS rubber (15% styrene), 60 grams hydrocarbon resin, 40 grams polymerized modified rosin ester and 2 grams stabilizer. Next, 272.7 grams acetone, 272.7 grams t-butyl acetate and 60.6 grams toluene were added and the solids were dissolved by mixing.

### Comparative Example 4

Into a quart jar were weighed 50 grams SIS (15% styrene), 50 grams 30% styrene SIS rubber, 60 grams hydrocarbon resin, 40 grams polymerized modified rosin ester, 10 grams naphthenic oil and 2 grams stabilizer. Next, 286.2 grams acetone, 286.2 grams t-butyl acetate and 63.6 grams toluene were added and the solids were dissolved by mixing.

Results of the qualitative evaluation of peel strength of the TPO to CDX plywood bond are given in Table 2.

TABLE 2
Qualitative TPO Bond to Plywood with SIS Adhesive

| | Comparative | Comparative | Comparative | Comparative |
|---|---|---|---|---|
| | Example 1 | Example 2 | Example 3 | Example 4 |
| Peel | Medium-Low | Medium-High | High | High |
| Strength | | | | |

Low styrene SIS and the low styrene SIS blend gave much better qualitative bond strength than high styrene SIS but these comparative examples had high VOC content and were unsuitable for use as environmentally friendly roofing adhesives. However, this series surprisingly revealed that low styrene SIS provides good bond strength.

### Working Example 1

### Peel Strength, No Zippering, Grab Tack-GAF Membrane

The formulation described as Example 1 was prepared as follows. To a quart container were added 100 grams SIS rubber (15% styrene), 300 grams hydrocarbon resin, 100 grams naphthenic oil and 4 grams stabilizer. Next, 180.9 grams toluene and 90.5 grams acetone were added and the solids were dissolved by mixing. The solids level was 65 weight percent.

The above example was tested only qualitatively since the solvent mixture has a high VOC level. The GAF Membrane/CDX plywood bond showed excellent grab tack with many long legs and a strong bond. However, due to the presence of large quantities of naphthenic oil and hydrocarbon resin, the heat resistance was poor.

### Working Example 2

### Peel Strength, No Zippering, Heat Aging, VOC Compliant—GAF Membrane

The formulation of Example 1 was altered to eliminate naphthenic oil, reduce the resin level and bring the solvent mix into VOC compliance. Into a quart container were weighed 100 grams SIS rubber (15% styrene), 150 grams hydrocarbon resin and 2 grams stabilizer. Next, 83.3 grams acetone, 83.3 grams toluene and 83.3 grams Oxsol 100 were added and the solids were dissolved by mixing.

Peel strength for Example 2 after 7 and 28 days aging at room temperature is given in Table 3.

TABLE 3
Example 2 Peel Strength after 7 and
28 Days Aging at Room Temperature

| | RT Age, | Peel, | | RT Age, | Peel, | |
|---|---|---|---|---|---|---|
| Example | Days | Pounds | Zipper | Days | Pounds | Zipper |
| 2 | 7 | 7.4 | No | 28 | 9.9 | No |

Peel strength was high and remained high after 28 days without evidence of “zippering.”

Peel strength for Example 2 after aging 7 and 28 days at 70° C. is shown in Table 4.

TABLE 4
Example 2 Peel Strength after 7 and 28 Days Aging at 70° C.

| | 70° C. | Peel, | | 70° C. | Peel, | |
|---|---|---|---|---|---|---|
| Example | Age, Days | Pounds | Zipper | Age, Days | Pounds | Zipper |
| 2 | 7 | 10.1 | No | 28 | 10.4 | No |

Surprisingly, there was no loss of peel strength after heat aging at 70° C. Peel strength was high and there was no “zippering.”

Grab strength was excellent for Example 2 with many long “legs” as the GAF Membrane/CDX plywood bond was pulled apart.

Moreover, Example 2 shows the same excellent peel strength with TPO membranes manufactured by different roofing materials suppliers with CDX plywood. Table 5 gives peel results after 69 days aging at 70° C.

TABLE 5
Example 2 Adhesive with Various TPO's after Aging 69 Days at 70° C.

| | 70° C. Age, | Peel, | |
|---|---|---|---|
| TPO | Days | Pounds | Zipper |
| 1 | 69 | 7.8 | No |
| 2 | 69 | 12.9 | No |

It is almost unprecedented for a TPO adhesive to survive 69 days at 70° C. with high peel and no “zippering.” It is even more surprising that the VOC compliant TPO adhesive gave good results for more than one TPO membrane.

### Working Example 3

### Firestone Membrane

The formulation of Example 2 was altered to reduce the resin level and alter the solvent mix somewhat (still VOC compliant). Into a quart container were weighed 100 grams SIS rubber (15% styrene), 100 grams hydrocarbon resin and 2 grams stabilizer. Next, 205 grams methyl acetate, 70 grams toluene and 51.3 grams Oxsol 100 were added and the solids were dissolved by mixing.

Example 3 was used to bond a Firestone Membrane to a variety of roofing substrates—brick, concrete, aluminum and galvanized steel. The results are displayed in Table 6.

TABLE 6
Example 3 Peel Strength Bonding TPO (Firestone
Membrane) to Roofing Substrates

| Brick | Brick | Concrete | Concrete | Aluminum | Aluminum | Galv | Galv |
|---|---|---|---|---|---|---|---|
| RT | 70° C. | RT | 70° C. | RT | 70° C. | RT | 70° C. |
| 2 Day | 6 Day | 2 Day | 6 Day | 2 Day | 6 Day | 2 Day | 6 Day |
| 7.4 lb | 11.1 lb | 10.2 lb | 11.0 lb | 2.8 lb | 3.6 lb | 3.4 lb | 3.7 lb |

Strengths are excellent for brick and concrete and good for the more difficult to bond surfaces, aluminum and galvanized steel.

Although the invention has been described in considerable detail through the preceding description and examples, this detail is for the purpose of illustration and is not to be construed as a limitation on the scope of the invention as it is described in the appended claims.

As used herein, and unless otherwise specified, “a” or “an” means “one or more.” All patents, applications, references, and publications cited herein are incorporated by reference in their entirety to the same extent as if they were individually incorporated by reference.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art, all language such as “up to,” “at least,” “greater than,” “less than,” and the like includes the number recited and refers to ranges which can be subsequently broken down into subranges as discussed above. Finally, as will be understood by one skilled in the art, a range includes each individual member.

It is specifically intended that the present invention not be limited to the embodiments and illustrations contained herein, but include modified forms of those embodiments including portions of the embodiments and combinations of elements of different embodiments as come within the scope of the following claims.

What is claimed is:

1. An adhesive composition comprising:
(a) a hydrocarbon resin,
(b) a styrene-isoprene-styrene block copolymer having a styrene content of no greater than 25 weight percent, based on the total weight of the polymer; and
(c) at least one organic solvent selected from the group consisting of acetone, methyl acetate, t-butyl acetate and parachlorobenzotrifluoride; and
(d) 0 to 20 weight percent of one or more additional organic solvents, based on the total weight of the composition;
the composition having a solids content of at least 25 weight percent, a viscosity of no greater than 5000 cps at 25° C., and a 7-day 180° peel strength at room temperature of at least 1253 grams/cm (7 lbs/inch) as measured by a modified ASTM D903 test.

2. The composition of claim 1, wherein the 180° peel strength remains the same, or increases, after heating for 7 days at 70° C.

3. The composition of claim 1, wherein the composition does not exhibit zippering when heated for 7 days at 70° C.

4. The composition of claim 1, further comprising a stabilizing agent.

5. The composition of claim 1 comprising no greater than 18 weight percent of the one or more additional organic solvents and having a solids content of at least 35 weight percent.

6. The composition of claim 5, having a solids content of at least 45 weight percent.

7. The composition of claim 5, in which the styrene-isoprene-styrene block copolymer has a styrene content of no greater than 20 weight percent, based on the total weight of the polymer.

8. The composition of claim 5 comprising:
(a) 30 to 70 weight percent hydrocarbon resin, based on the total weight of the composition; and
(b) 30 to 70 weight percent styrene-isoprene-styrene block copolymer, based on the total weight of the composition;
wherein 60 to 90 weight percent of the organic solvent in the composition is selected from the group consisting of acetone, methyl acetate, t-butyl acetate and parachlorobenzotrifluoride.

9. The composition of claim 1, in which the one or more additional organic solvents consists of toluene, and further wherein the toluene makes up 10 to 18 weight percent of the composition, based on the total weight of components (a) through (d).

10. The composition of claim 1, in which the styrene-isoprene-styrene block copolymer is a linear triblock styrene-isoprene-styrene copolymer.

11. A method for bonding a first surface to a second surface, the method comprising applying the composition of claim 1 to at least one of the first surface and the second surface and contacting the first surface to the second surface.

12. The method of claim 11, in which at least one of the first and second surfaces is the surface of a roofing membrane.

13. The method of claim 12, in which at least one of the first and second surfaces comprises a thermoplastic polyolefin.

14. The method of claim 13, in which the other one of the first and second surfaces is brick, concrete or aluminum.

15. The method of claim 13, in which both the first surface and the second surface comprise a thermoplastic polyolefin.
